(19) United States
(12) Patent Application Publication
(10) Pub. No.: US 2009/0108977 A1
(43) Pub. Date: Apr. 30, 2009

(54) TRANSFORMER

(75) Inventors: Hong-Fei Chen, Taichung City (TW); Ting-Cheng Lai, Taichung (TW); Shu-Bin Wang, Taichung (TW)

Correspondence Address: CHOATE, HALL & STEWART LLP, TWO INTERNATIONAL PLACE, BOSTON, MA, 02110, US

(73) Assignee: Greatchip Technology Co.,Ltd., Taichung (TW)

(21) Appl. No.: 12/257,088

(22) Filed: Oct. 23, 2008

(30) Foreign Application Priority Data
Oct. 25, 2007 (TW) 096140063

(51) Int. Cl. H01F 27/30

(52) U.S. Cl. 336/198

(57) ABSTRACT

A transformer includes a bobbin unit, a primary winding, a secondary winding, and a core unit. The bobbin unit has a first winding portion and a second winding portion. The primary winding is wound around the first winding portion of the bobbin unit. The secondary winding is wound around the second winding portion of the bobbin unit, and is coupled electromagnetically to the primary winding. The core unit is mounted to the bobbin unit, and includes a first core part, and a second core part that forms a magnetic circuit path with the first core part. The first core part is movable relative to the second core part from a tunable position to an assembled position for varying a size of an effective magnetic flux region defined between the first core part and the second core part.

### CROSS-REFERENCE TO RELATED APPLICATION

This application claims priority of Taiwanese Application No. 096140063, filed on Oct. 25, 2007.

### BACKGROUND OF THE INVENTION

1. Field of the Invention

The invention relates to a transformer, more particularly to a transformer that permits relative movement between first and second core parts for adjusting leakage inductance during a fabrication process of the transformer.

2. Description of the Related Art

Shown in FIG. 1 is a conventional transformer 100 used in a backlight module. The conventional transformer 100 includes a core unit 11, a bobbin unit 12 mounted to the core unit 11, a primary winding 13 wound around the bobbin unit 12, and a secondary winding 14 wound around the bobbin unit 12. Each backlight module contains a plurality of the conventional transformers 100 in order to drive a plurality of lamps (not shown). The secondary windings 14 of the conventional transformers 100 that are adapted to be connected to the lamps should have identical inductances in order to ensure that balanced currents are provided to the lamps, thereby ensuring identical luminance of the lamps.

However, errors are common during fabrication of the core unit 11 of the conventional transformer 100. Taking the core unit 11 of the conventional transformer 100 as an example, this core unit 11 belongs to a core type that should have no air gaps. However, a lot of variables during sintering would influence the fabrication. Consequently, in a fabricated conventional transformer 100, it is normal to find an inductance error of up to 40% and a leakage inductance error of up to 10%, both of which are extremely far beyond the desired tolerance range of 1%. Extra processes, such as grinding and machining, may be conducted to improve the quality of these inferior products, but these extra processes consume a lot of time. As a result, a lot of the inferior products are simply discarded, resulting in a low yield rate and a high fabrication cost.

Moreover, for a lot of transformers, the core unit is a combination of two or more core parts, e.g., the core unit 11 of FIG. 1 includes an I-shaped core part 111a and an 0-shaped core part 111b. However, for a core unit that is composed of two E-shaped core parts, a significant amount of leakage inductance results from an air gap adjacent to the primary winding and would adversely affect the output of the transformer. In addition, under the present technology, it is not possible to adjust magnetic flux at the secondary winding side while maintaining magnetic flux at the primary winding side of the transformer.

### SUMMARY OF THE INVENTION

Therefore, an object of the present invention is to provide a transformer that permits adjustment of leakage inductance by varying an effective magnetic flux region through structurally adjusting relative positioning of the transformer during the fabrication process so as to meet the requisite tolerances set forth for acceptable products to thereby increase the production yield of the transformer.

According to an embodiment of the present invention, there is provided a transformer that includes a bobbin unit, a primary winding, a secondary winding, and a core unit. The bobbin unit has a first winding portion and a second winding portion. The primary winding is wound around the first winding portion of the bobbin unit. The secondary winding is wound around the second winding portion of the bobbin unit, and is coupled electromagnetically to the primary winding. The core unit is mounted to the bobbin unit, and includes a first core part, and a second core part that forms a magnetic circuit path with the first core part. The first core part is movable relative to the second core part from a tunable position to an assembled position for varying a size of an effective magnetic flux region defined between the first core part and the second core part.

An advantage of the present invention resides in that, during fabrication, relative positions of the first and second core parts can be adjusted so as to ensure that the magnetic flux of the transformer meets the standard production requirement and to in turn achieve the object of increasing the production yield of the transformer.

### BRIEF DESCRIPTION OF THE DRAWINGS

Other features and advantages of the present invention will become apparent in the following detailed description of the embodiments with reference to the accompanying drawings, of which:

FIG. 1 is an exploded perspective view of a conventional transformer;

FIG. 2 is a top schematic view of a first embodiment of a transformer;

FIG. 3 is a partly sectional schematic side view of the first embodiment;

FIG. 4 is a fragmentary perspective view of the first embodiment;

FIG. 5 is an exploded perspective view of a second embodiment of a transformer;

FIG. 6 is an exploded perspective view of a variation of the second embodiment;

FIG. 7 is an exploded perspective view of a third embodiment of a transformer;

FIG. 8 is a schematic top view of a fourth embodiment of a transformer, where a bobbin unit is omitted for the sake of simplicity;

FIG. 9 is a schematic perspective view of a fifth embodiment of a transformer, where the bobbin unit is omitted for the sake of simplicity;

FIG. 10 is a schematic perspective view of a sixth embodiment of a transformer, where the bobbin unit is omitted;

FIG. 11 is an exploded perspective view of a core unit of the seventh embodiment of a transformer;

FIG. 12 is a partly sectional schematic view of a seventh embodiment, where the bobbin unit is omitted for the sake of simplicity;

FIG. 13 is a schematic perspective view of a eighth embodiment of a transformer, where the bobbin unit is omitted for the sake of simplicity;

FIG. 14 is a schematic perspective view of a ninth embodiment of a transformer, where the bobbin unit is omitted for the sake of simplicity;

FIG. 15 is a schematic view of a tenth embodiment of a transformer, where the bobbin unit is omitted for the sake of simplicity;

FIG. 16 is a schematic view of a eleventh embodiment of a transformer, where the bobbin unit is omitted;

FIG. 17 is a schematic view of a twelfth embodiment of a transformer, where the bobbin unit is omitted for the sake of simplicity;

FIG. 18 is a schematic view of a thirteenth embodiment of a transformer, where the bobbin unit is omitted for the sake of simplicity;

FIG. 19 is a schematic view of a fourteenth embodiment of a transformer, where the bobbin unit is omitted for the sake of simplicity;

FIG. 20 is a schematic top view of a fifteenth embodiment of a transformer; and

FIG. 21 is an exploded perspective view of the fifteenth embodiment, where a primary winding and a secondary winding are omitted for the sake of simplicity.

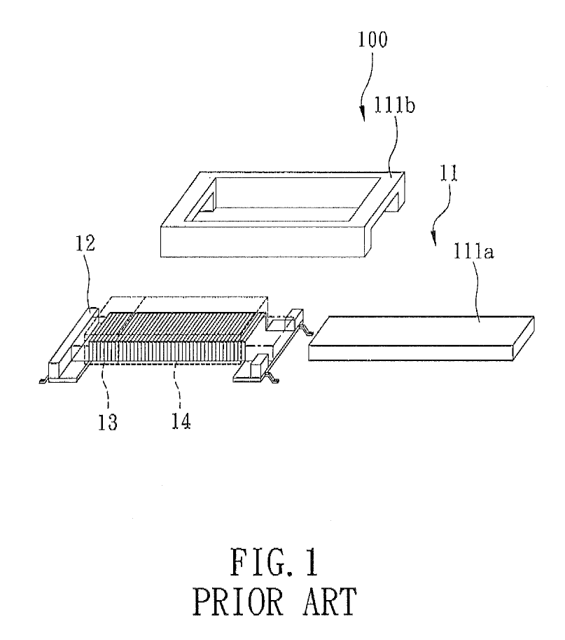

### DETAILED DESCRIPTION OF THE EMBODIMENTS

Before embodiments of the present invention is described in greater detail, it should be noted that like elements are denoted by the same reference numerals throughout the disclosure.

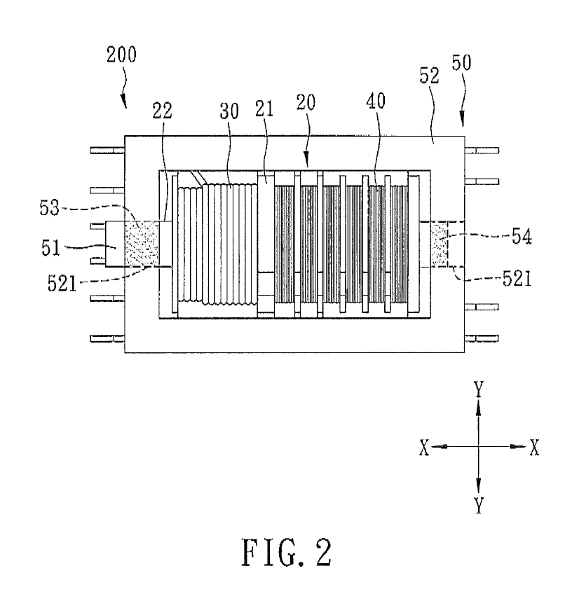

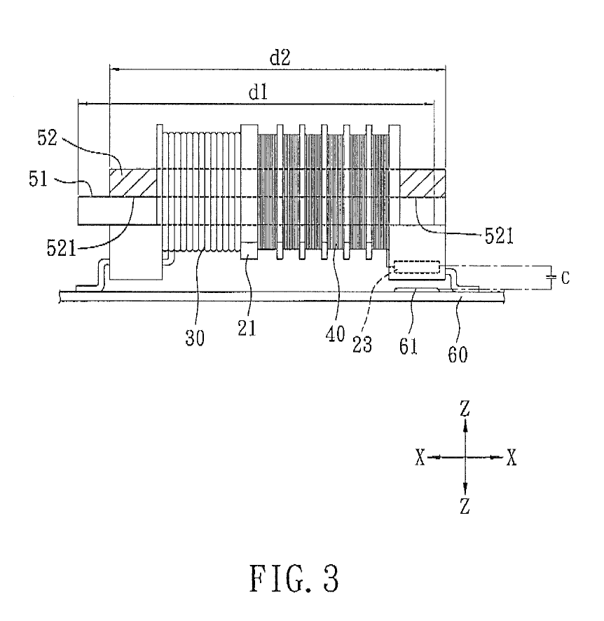

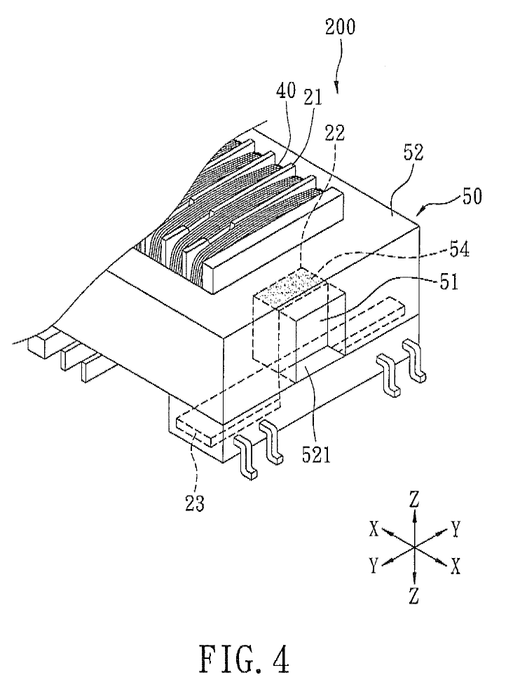

Referring to FIG. 2, FIG. 3 and FIG. 4, the first embodiment of a transformer 200 according to the present invention includes a bobbin unit 20, a primary winding 30, a secondary winding 40, and a core unit 50.

The bobbin unit 20 has a first winding portion and a second winding portion.

The primary winding 30 is wound around the first winding portion of the bobbin unit 20.

The secondary winding 40 is wound around the second winding portion of the bobbin unit 20, and is coupled electromagnetically to the primary winding 30.

The core unit 50 is mounted to the bobbin unit 20, and includes a first core part 51, and a second core part 52 that forms a magnetic circuit path with the first core part 51. The first core part 51 is movable relative to the second core part 52 from a tunable position to an assembled position for varying a size of an effective magnetic flux region defined between the first core part 51 and the second core part 52.

It should be noted herein that FIG. 2 is a top view of the first embodiment, FIG. 3 is a partly sectional schematic side view of the first embodiment, where the second core part 52 is sectioned, and FIG. 4 is a fragmentary perspective view of the first embodiment.

In this embodiment, the effective magnetic flux region is an effective secondary magnetic flux area 54 defined between the first core part 51 and the second core part 52 and proximate to the secondary winding 40. The size of the effective secondary magnetic flux area 54 is varied while a size of an effective primary magnetic flux area 53 defined between the first core part 51 and the second core part 52 and proximate to the primary winding 30 is maintained. The effective primary and secondary magnetic flux areas 53, 54 are respectively represented by the shaded regions where the first and second core parts 51, 52 overlap.

In this embodiment, the bobbin unit 20 includes a main body 21 that is formed with a core-receiving compartment 22 along a longitudinal direction (X), and that has the first and second winding portions. The first core part 51 extends through the core-receiving compartment 22, and is movable relative to the second core part 52 in the longitudinal direction (X) from the tunable position to the assembled position. In addition, the bobbin unit 20 is specifically structured so as not to hinder movement of the first core part 51 relative to the second core part 52 in the longitudinal direction (X). The bobbin unit 20 further includes an electrically conductive plate 23 embedded in the main body 21, connected electrically to one of the primary and secondary windings 30, 40, and adapted to define a capacitor (C) with a metal part 61 of a circuit board 60, to which the transformer 200 is mounted. The capacitor (C) may serve as a detector for a protecting circuit (not shown) for detecting abnormality of said one of the primary and secondary windings 30, 40.

In the first embodiment, the first core part 51 is an elongated core part that extends in a longitudinal direction (X). The second core part 52 is an 0-shaped core part that has opposite longitudinal sides, which extend in the longitudinal direction (X), and opposite lateral sides, which extend in a transverse direction (Y) perpendicular to the longitudinal direction (X). The second core part 52 is formed with two grooves 521 respectively in the lateral sides. Each of the grooves 521 extends in a vertical direction (Z) perpendicular to the longitudinal direction (X) and the transverse direction (Y). The first core part 51 extends into the grooves 521. The primary and secondary effective magnetic flux areas 53, 54 are contact areas between the first and second core parts 51, 52 in the grooves 521 respectively proximate to the primary and secondary windings 30, 40.

As shown in FIG. 3, a length (d1) of the first core part 51 is greater than or equal to a greatest possible distance (d2) between the effective secondary magnetic flux area 54 and the effective primary magnetic flux area 53 in this embodiment. By making the length (d1) of the first core part 51 greater than or equal to the greatest possible distance (d2) between the effective primary and secondary magnetic flux areas 53, 54, a portion of the first core part 51 extends outside of the core-receiving compartment 22 in the main body 21 of the bobbin unit 20 and one of the grooves 521 so as to be easily accessible by a fabricating personnel for moving the first core part 51 relative to the second core part 52 in the longitudinal direction (X) during adjustment of the size of the effective secondary magnetic flux area 54 while maintaining the size of the primary magnetic flux area 53.

During fabrication of the transformer 200, the first core part 51 is moved relative to the second core part 52 until the size of the effective secondary magnetic flux area 54 is one such that an error of a leakage inductance for the secondary winding 40 falls within a standard product requirement of, for instance, 1%, at which point the first core part 51 is disposed at the assembled position, and is ready to be fixed in position with the use of an adhesive. Consequently, it can be ensured, during fabrication of the transformer 200, that the transformer 200 compiles with the product requirement, thereby increasing the production yield of the transformer 200. As shown in FIG. 2, in this embodiment, the size of the effective secondary magnetic flux area 54 is different from the size of the effective primary magnetic flux area 53.

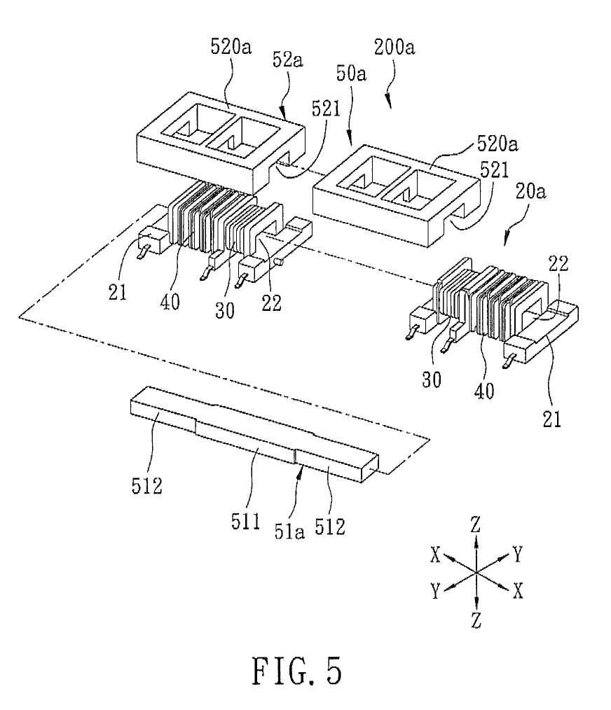

As shown in FIG. 5, the second embodiment of a transformer 200a according to the present invention differs from the transformer 200 of the first embodiment in that the bobbin unit 20a of the transformer 200a includes two of the main bodies 21. The main bodies 21 are connected to each other such that the first winding portions are disposed adjacent to each other and such that the second winding portions are disposed distal from each other.

Furthermore, the transformer 200a includes two of the primary windings 30, each of which is wound around the first winding portion of a corresponding one of the main bodies 21, and two of the secondary windings 40, each of which is wound around the second winding portion of a corresponding one of the main bodies 21.

The first core part 51a extends in the longitudinal direction (X) through the core-receiving compartments 22 in the main bodies 21, and is movable relative to the second core part 52a in the longitudinal direction (X) from the tunable position to the assembled position.

The first core part 51a includes a central segment 511 and two end segments 512 that are disposed at opposite ends of the central segment 511 in the longitudinal direction (X). The central segment 511 corresponds to the primary windings 30, and has a first cross-sectional area in a plane perpendicular to the longitudinal direction (X), i.e., the (Y-Z) plane. The end segments 512 respectively correspond to the secondary windings 40, and respectively have a second cross-sectional area in the (Y-Z) plane that is smaller than the first cross-sectional area. The different first and second cross-sectional areas create different magnetic resistances, and therefore would create abundant magnetic resistance variations with the movement of the first core part 51a in the longitudinal direction (X) relative to the second core part 52a.

In the second embodiment, the second core part 52a of the core unit 50a is composed of two 8-shaped sub-core parts 520a that are connected to each other. Each of the sub-core parts 520a has opposite longitudinal sides, which extend in the longitudinal direction (X), and three transverse sections, which extend in a transverse direction (Y). Each of the transverse sections extends between the longitudinal sides. Each of the sub-core parts 520a is formed with three grooves 521 respectively in the transverse sections. Each of the grooves 521 extends in the vertical direction (Z) perpendicular to the longitudinal direction (X) and the transverse direction (Y). The first core part 51a extends into the grooves 521 of the sub-core parts 520a.

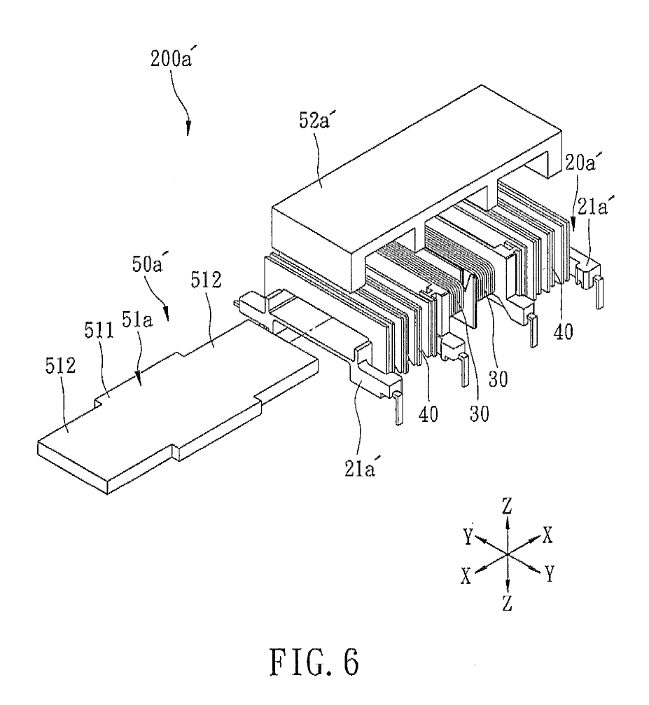

Shown in FIG. 6 is a variation of the second embodiment, where the second core part 52a′ of the core unit 50a′ has a longitudinal side that extends in the longitudinal direction (X), and four vertical sections that extend from the longitudinal side in the vertical direction (Z). Each of the main bodies 21a′ of the bobbin unit 20a′ is formed with an extension groove for permitting extension of a corresponding one of the vertical sections of the second core part 52a′ therein so as to be disposed in contact with the first core part 51a.

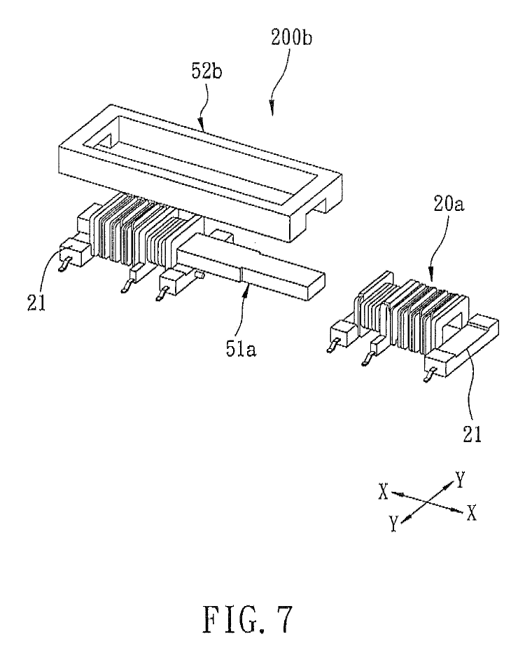

With reference to FIG. 7, the third embodiment of a transformer 200b according to the present invention differs from the transformer 200a of the second embodiment only in that the second core part 52b of the transformer 200b is an 0-shaped core part. It can be seen from the second and third embodiments that the second core part 52a, 52b can have varying structures, while still being able to achieve the object of adjusting the leakage inductance of the secondary winding 40 by moving the first core part 51a relative to the second core part 52a, 52b.

In the following embodiments, unless otherwise necessary, the bobbin unit 20 is omitted from the drawings, and the primary and secondary windings 30, 40 are illustrated by blocks using imaginary lines for the sake of simplicity.

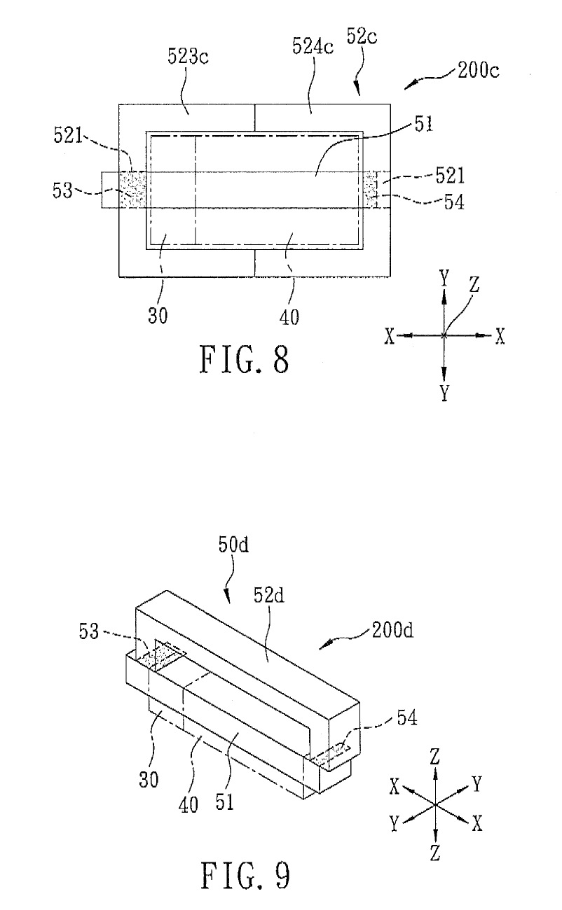

With reference to FIG. 8, the fourth embodiment of a transformer 200c according to the present invention differs from the transformer 200 (shown in FIG. 2) of the first embodiment in that the second core part 52c of the transformer 200c includes first and second sub-core parts 523c, 524c. The first core part 51 extends in the longitudinal direction (X), and is movable relative to the first and second sub-core parts 523c, 524c in the longitudinal direction (X) from the tunable position to the assembled position. Each of the first and second sub-core parts 523c, 524c is a C-shaped part that has opposite longitudinal sides extending in the longitudinal direction (X) and a lateral side extending in the transverse direction (Y) perpendicular to the longitudinal direction (X). The first and second sub-core parts 523c, 524c are disposed in contact with each other in the longitudinal direction (X) such that the lateral sides of the first and second sub-core parts 523c, 524c face each other. Each of the first and second sub-core parts 523c, 524c is formed with a groove 521 in the lateral side thereof that extends in the vertical direction (Z) perpendicular to the longitudinal direction (X) and the transverse direction (Y). The first core part 51 extends into the grooves 521 in the first and second sub-core parts 523c, 524c. The primary effective magnetic flux area 53 is a contact area between the first core part 51 and the first sub-core part 523c in the groove 521 in the first sub-core part 523c and proximate to the primary winding 30. The secondary effective magnetic flux area 54 is a contact area between the first core part 51 and the second sub-core part 524c in the groove 521 in the second sub-core part 524c and proximate to the secondary winding 40.

With reference to FIG. 9, the fifth embodiment of a transformer 200d according to the present invention differs from the transformer 200 (as shown in FIG. 2) of the first embodiment in that the second core part 52d of the core unit 50d of the transformer 200d is a C-shaped core part that has a longitudinal side and opposite vertical sides. The longitudinal side extends in the longitudinal direction (X). Each of the vertical sides extends in the vertical direction (Z) perpendicular to the longitudinal direction (X) and the transverse direction (Y), and has an end surface in a plane perpendicular to the vertical direction (Z), i.e., the (X-Y) plane. The end surfaces of the vertical sides are disposed in contact with the first core part 51. The primary and secondary effective magnetic flux areas 53, 54 respectively are areas of the end surfaces of the vertical sides of the second core part 52d that are disposed in contact with the first core part 51 and that are respectively disposed proximate to the primary and secondary windings 30, 40. The first core part 51 is movable relative to the second core part 52d in the longitudinal direction (X) from the tunable position to the assembled position.

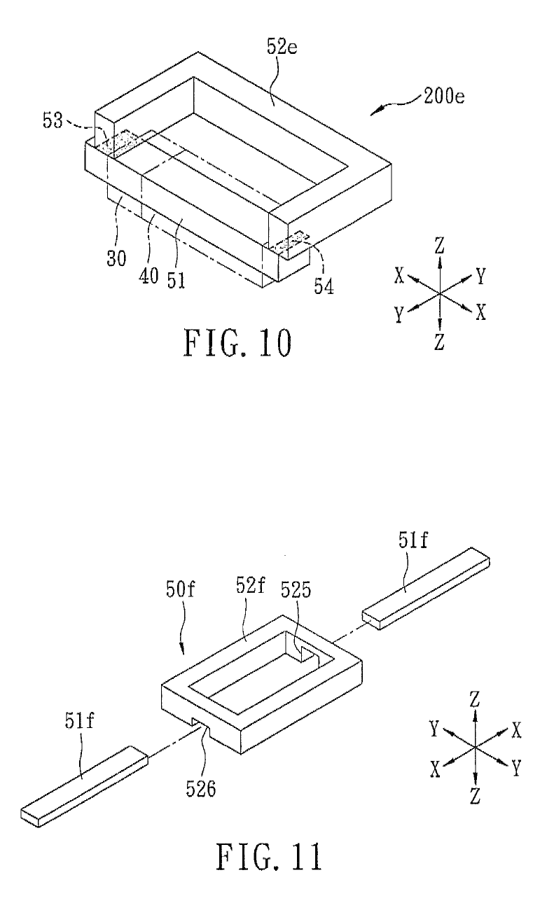

With reference to FIG. 10, the sixth embodiment of a transformer 200e according to the present invention differs from the transformer 200 (as shown in FIG. 2) of the first embodiment mainly in that the second core part 52e of the transformer 200e is a U-shaped core part that has a longitudinal side, and opposite transverse sides. The longitudinal side extends in the longitudinal direction (X). Each of the transverse sides extends in the transverse direction (Y) perpendicular to the longitudinal direction (X), and has a side surface in a plane of the longitudinal and transverse directions (X, Y). The side surfaces of the transverse sides are disposed in contact with the first core part 51. The primary and secondary effective magnetic flux areas 53, 54 respectively are areas of the side surfaces of the transverse sides of the second core part 52e that are disposed in contact with the first core part 51, and that are respectively disposed proximate to the primary and secondary windings 30, 40. The first core part 51 is movable relative to the second core part 52e in the longitudinal direction (X) from the tunable position to the assembled position.

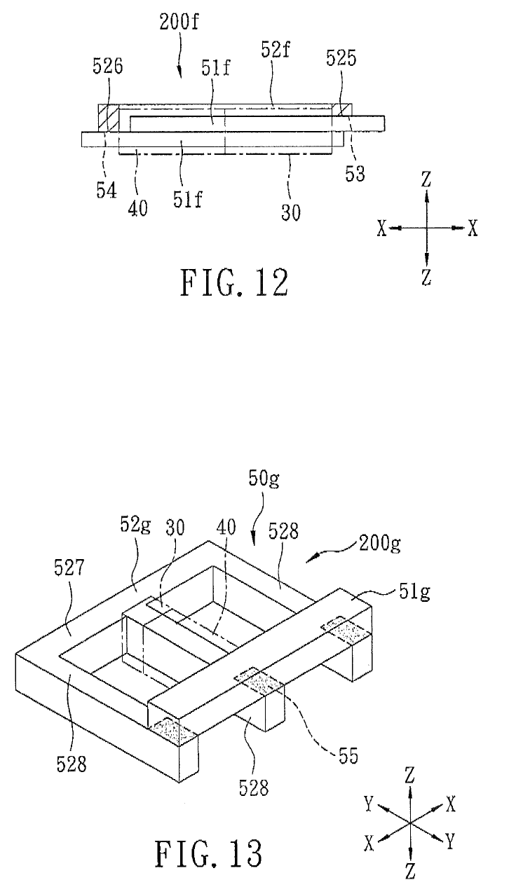

With reference to FIG. 11 and FIG. 12, the seventh embodiment of a transformer 200f according to the present invention differs from the transformer 200 (as shown in FIG. 2) of the first embodiment mainly in that the core unit 50f of the transformer 200f includes two of the first core parts 51f. Each of the first core parts 51f is an elongated core part that extends in the longitudinal direction (X). The second core part 52f is an 0-shaped core part that has opposite longitudinal sides, which extend in the longitudinal direction (X), and opposite lateral sides, which extend in the transverse direction (Y) perpendicular to the longitudinal direction (X). The first core parts 51f are stacked in the vertical direction (Z) perpendicular to the longitudinal direction (X) and the transverse direction (Y). In addition, the second core part 52f is formed with a first groove 525 in one of the lateral sides that is proximate to the primary winding 30, and a second groove 526 in the other one of the lateral sides that is proximate to the secondary winding 40. The first groove 525 has a size in the vertical direction (Z) that permits extension of both of the stacked first core parts 51 f therein in the longitudinal direction (X). The second groove 526 has a size in the vertical direction (Z) that permits extension of only a lower one of the stacked first core parts 51f therein in the longitudinal direction (X).

In the seventh embodiment, the effective primary magnetic flux area 53 is a contact area between an upper one of the stacked first core parts 51f with the second core part 52f in the first groove 525. The effective secondary magnetic flux area 54 is a contact area between the lower one of the stacked first core parts 51f with the second core part 52f in the second groove 526. The lower one of the first core parts 51f is movable relative to the second core part 52f in the longitudinal direction (X) from the tunable position to the assembled position.

With reference to FIG. 13, the eighth embodiment of a transformer 200g according to the present invention mainly differs from the previous embodiments in that the effective magnetic flux region of the transformer 200g to be varied is not the effective 25 secondary magnetic flux area 54 as defined for the previous embodiments. In addition, it is not of significant concern whether the size of the effective magnetic flux region is varied while the size of the effective primary magnetic flux area 53 as defined for the previous embodiments is maintained.

In the eighth embodiment, the first core part 51g of the core unit 50g is an elongated core part that extends in the longitudinal direction (X). The second core part 52g is an E-shaped core part, and includes a connecting segment 527 and three extension segments 528. The connecting segment 527 extends in the longitudinal direction (X). The extension segments 528 extend from the connecting segment 527 in the transverse direction (Y) perpendicular to the longitudinal direction (X), and are spaced apart from each other.

The first core part 51g is disposed in the vertical direction (Z) perpendicular to the longitudinal direction (X) and the transverse direction (Y) relative to the second core part 52g. The effective magnetic flux region is an area of contact between the first core part 51g and a central one of the extension segments 528 of the second core part 52g that is interposed between the other two of the extension segments 528, and is illustrated by the shaded region with reference numeral 55. The first core part 51g is movable in the transverse direction (Y) relative to the second core part 52g from the tunable position to the assembled position.

In this embodiment, the central one of the extension segments 528 of the second core part 52g extends into the bobbin unit 20 (as shown in FIG. 2) such that the primary and secondary windings 30, 40 are respectively distal from and proximate to the first core part 51g.

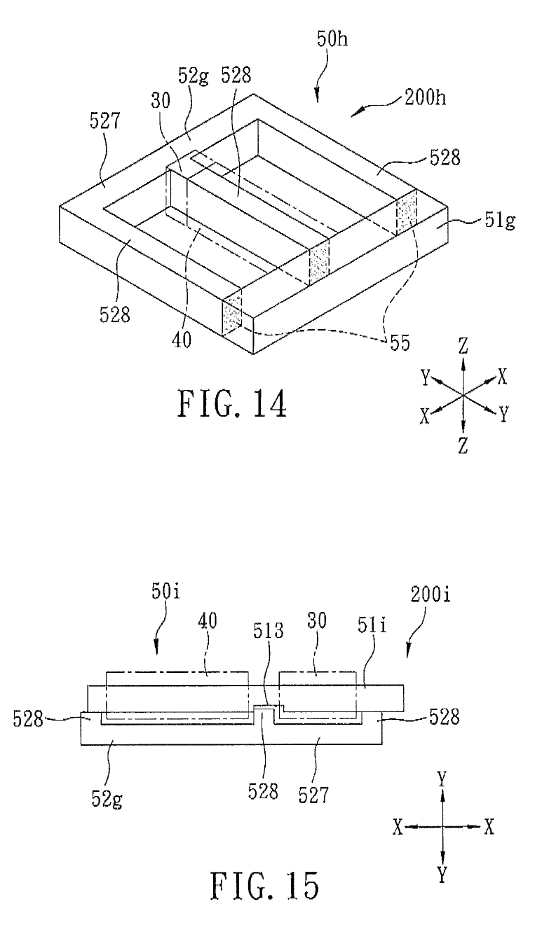

With reference to FIG. 14, the ninth embodiment of a transformer 200h according to the present invention differs from the transformer 200g of the eighth embodiment in the configuration of the core unit 50h of the transformer 200h. In the ninth embodiment, the first core part 51g of the core unit 50h is disposed in the transverse direction (Y) relative to the second core part 52g. The effective magnetic flux region is defined as areas of contact between the first core part 51g and two outer ones of the extension segments 528 of the second core part 52g that have a central, one of the extension segments 528 interposed there between, and is illustrated by the shaded regions with reference numeral 55. The first core part 51g is movable in the longitudinal direction (X) relative to the second core part 52g from the tunable position to the assembled position.

Moreover, the first core part 51g has a length in the longitudinal direction (X) that is not smaller than that of the connecting segment 527 of the second core part 52g. In this embodiment, the length of the first core part 51g in the longitudinal direction (X) is equal to that of the connecting segment 527 of the second core part 52g.

Similar to the eighth embodiment, the central one of the extension segments 528 of the second core part 52g extends into the bobbin unit 20 (as shown in FIG. 2) such that the primary and secondary windings 30, 40 are respectively distal from and proximate to the first core part 51g.

With reference to FIG. 15, the tenth embodiment of a transformer 200i according to the present invention differs from the transformer 200h of the ninth embodiment in that the first core part 51i of the core unit 51i of the transformer 200i is an elongated core part that extends in the longitudinal direction (X), and is formed with a groove 513. The groove 513 extends in the transverse direction (Y), and has a size in the longitudinal direction (X) greater than that of the central one of the extension segments 528 of the second core part 52g that is interposed between the other two of the extension segments 528.

The first core part 51i is disposed in the transverse direction (Y) relative to the second core part (X) such that the groove 513 is registered with the central one of the extension segments 528, and such that there is an air gap between the first core part 51i and the central one of the extension segments 528.

In the tenth embodiment, the first core part 51i is movable in the longitudinal direction (X) relative to the second core part 52g from the tunable position to the assembled position for varying configuration of the air gap so as to vary the size of the effective magnetic flux region.

Different from the previous embodiments, the bobbin unit (not shown) of the tenth embodiment is formed with an extension groove (not shown) disposed between the primary and secondary windings 30, 40. The central one of the extension segments 528 of the second core 52g extends through the extension groove so as to form the air gap with the groove 513 in the first core part 51i. The first core part 51i extends into the bobbin unit.

Moreover, the first core part 51i has a length in the longitudinal direction (X) that is not smaller than that of the connecting segment 527 of the second core part 52g. In this embodiment, the length of the first core part 51i in the longitudinal direction (X) is equal to that of the connecting segment 527 of the second core part 52g.

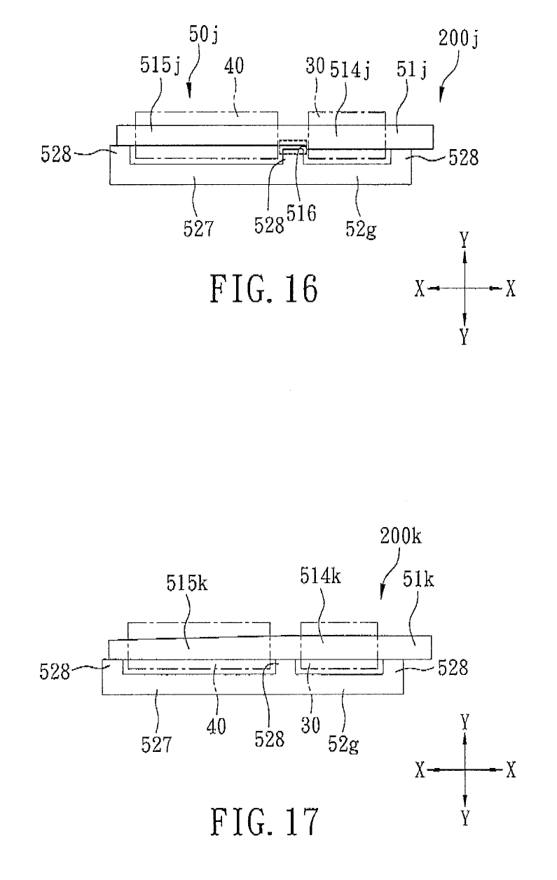

With reference to FIG. 16, the eleventh embodiment of a transformer 200j according to the present invention differs from the transformer 200i of the tenth embodiment in that the first core part 51j of the core unit 50j of the transformer 200j is an elongated core part that extends in the longitudinal direction (X), and that has a thick segment 514j and a thin segment 515j. The thin segment 515j is thinner in the transverse direction (Y) than the thick segment 514j such that the thick and thin segments 514j, 515j cooperate to form a junction 516 there between. The central one of the extension segments 528 of the second core part 52g is registered with the thin segment 515j such that the central one of the extension segments 528 of the second core part 52g forms an air gap with the junction 516.

In this embodiment, the first core part 51j is movable in the longitudinal direction (X) relative to the second core part 52g from the tunable position to the assembled position for varying configuration of the air gap so as to vary the size of the effective magnetic flux region.

Different from the previous embodiment, the first core part 51j extends into the bobbin unit (not shown) with the junction 516 disposed between the primary and secondary windings 30, 40. The bobbin unit is formed with an extension groove for permitting the central one of the extension segments 528 of the second core part 52g to extend therein so as to form the air gap with the junction 516 of the first core part 51j.

The first core part 51j has a length in the longitudinal direction (X) that is not smaller than that of the connecting segment 527 of the second core part 52g. In this embodiment, the length of the first core part 51j in the longitudinal direction (X) is equal to that of the connecting segment 527 of the second core part 52g.

With reference to FIG. 17, the twelfth embodiment of a transformer 200k according to the present invention differs from the transformer 200j of the eleventh embodiment mainly in that the first core part 51k of the transformer 200k is an elongated core part that extends in the longitudinal direction (X), and that has a first segment 514k and a second segment 515k disposed adjacent to each other. The second segment 515k has a size in the transverse direction (Y) that gradually decreases along the longitudinal direction (X) away from the first segment 514k. In addition, the central one of the extension segments 528 of the second core part 52g is disposed in contact with the second segment 515k of the first core part 51k.

In this embodiment, the first core part 51k is movable in the longitudinal direction (X) relative to the second core part 52g from the tunable position to the assembled position for adjusting relative position of the second segment 515k of the first core part 51k with the central one of the extension segments 528 of the second core part 52g so as to vary the size of the effective magnetic flux region.

In this embodiment, the first core part 51k extends into the bobbin unit (not shown). The bobbin unit is formed with an extension groove (not shown), and the central one of the extension segments 528 of the second core part 52g extends through the extension groove in the bobbin unit so as to be disposed in contact with the second segment 515k of the first core part 51k. The primary winding 30 is wound around the first segment 514k of the first core part 51k, and the secondary winding 40 is wound around the second segment 515k of the first core part 51k.

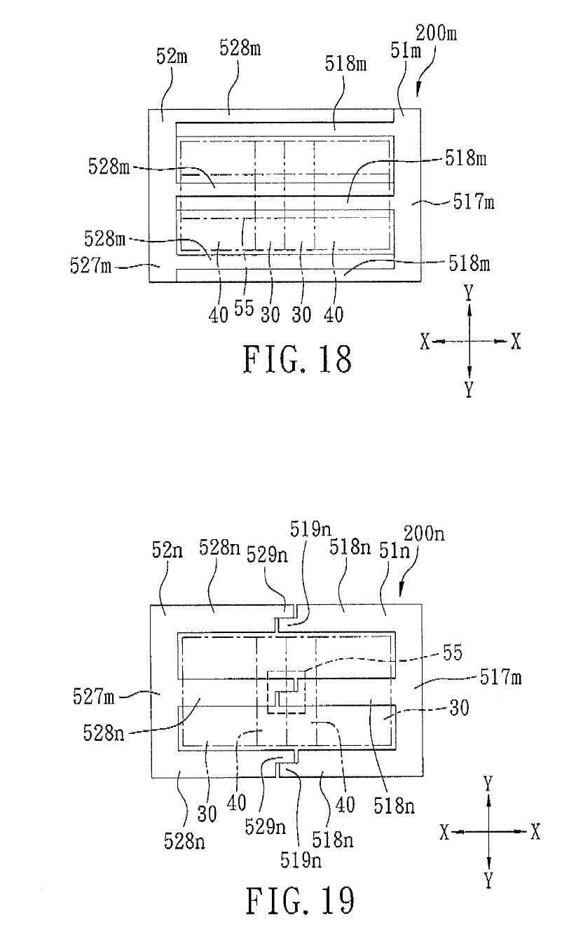

With reference to FIG. 18, the thirteenth embodiment of a transformer 200m according to the present invention differs from the previous embodiments mainly in that each of the first and second core parts 51m, 52m of the transformer 200m is an E-shaped core part, and includes a connecting segment 517m, 527m and three extension segments 518m, 528m. The connecting segments 517m, 527m extend in the transverse direction (Y). The extension segments 518m, 528m of each of the first and second core parts 51m, 52m extend from the connecting segment 517m, 527m in the longitudinal direction (X), and are spaced apart from each other. The first and second core parts 51m, 52m are disposed such that each of the extension segments 518m of the first core part 51m is disposed in contact with a corresponding one of the extension segments 528m of the second core part 52m along the longitudinal direction (X), and such that the effective magnetic flux region is defined by a central one of the extension segments 518m of the first core part 51m and the corresponding one of the extension segments 528m of the second core part 52m, and is denoted by reference number 55.

In this embodiment, the first core part 51m is movable relative to the second core part 52m in the longitudinal direction (X) from the tunable position to the assembled position for varying the size of the effective magnetic flux region 55.

Furthermore, the transformer 200m of the thirteenth embodiment includes two of the primary windings 30 disposed adjacent to each other, and two of the secondary windings 40 disposed distal from each other. The central one of the extension segments 518m of the first core part 51m and the corresponding one of the extension segments 528m of the second core part 52m extend into the bobbin unit (not shown).

With reference to FIG. 19, the fourteenth embodiment of a transformer 200n according to the present invention differs from the transformer 200m of the thirteenth embodiment mainly in that each of the extension segments 518n, 528n of the first and second core parts 51n, 52n of the transformer 200n has an end remote from the connecting segment 517m, 527m that is provided with a protrusion 519n, 529n in the longitudinal direction (X). The first and second core parts 51n, 52n are disposed such that each of the extension segments 518n of the first core part 51n is registered with a corresponding one of the extension segments 528n of the second core part 52n in the longitudinal direction (X), and such that the protrusion 519n of each of the extension segments 518n of the first core part 51n is disposed in contact with the protrusion 529n of the corresponding one of the extension segments 528n of the second core part 52n in the transverse direction (Y).

The effective magnetic flux region is defined between the protrusion 519n of a central one of the extension segments 518n of the first core part 51n and the protrusion 529n of the corresponding one of the extension segments 528n of the second core part 52n, and is denoted by reference numeral 55.

In this embodiment, the first core part 51n is movable relative to the second core part 52n in the longitudinal direction (X) from the tunable position to the assembled position for varying the size of the effective magnetic flux region 55.

In this embodiment, the transformer 200n includes two of the primary windings 30 disposed adjacent to each other, and two of the secondary windings 40 disposed distal from each other. The central one of the extension segments 518n of the first core part 51n and the corresponding one of the extension segments 528n of the second core part 528n extend into the bobbin unit (not shown).

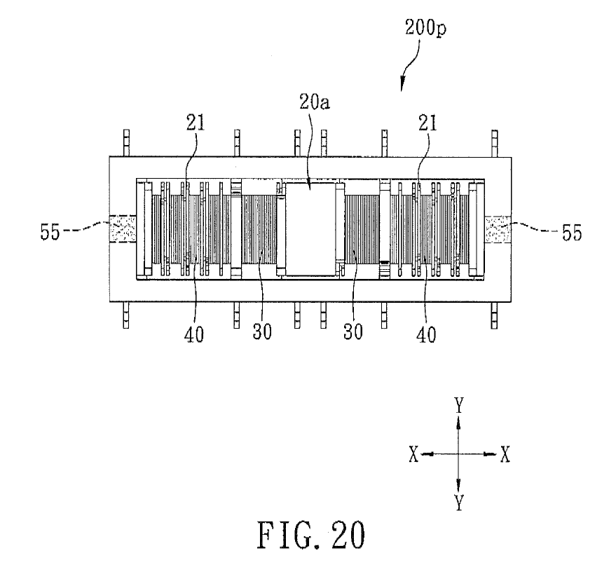

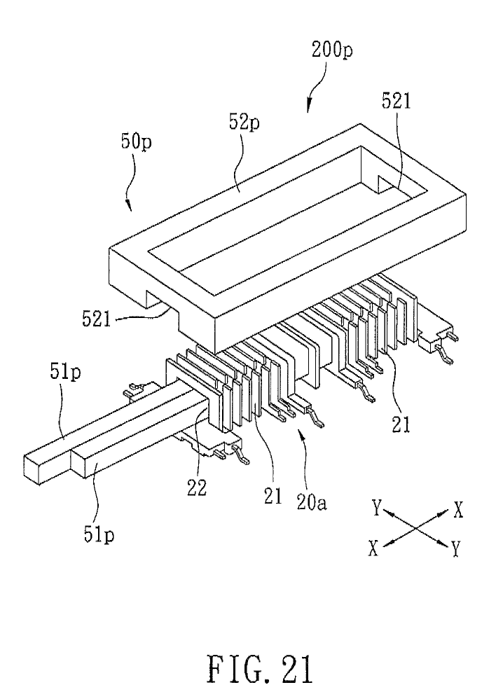

With reference to FIG. 20 and FIG. 21, the fifteenth embodiment of a transformer 200p according to the present invention differs from the transformer 200a (as shown in FIG. 5) of the second embodiment mainly in that the core unit 50p of the transformer 200p includes two of the first core parts 51p. Each of the first core parts 51p is an elongated core part that extends in the longitudinal direction (X). The second core part 52p is an O-shaped core part that has opposite longitudinal sides, which extend in the longitudinal direction (X), and opposite lateral sides, which extend in the transverse direction (Y). The first core parts 51p are juxtaposed in the transverse direction M.

The second core part 52p is formed with two grooves 521 respectively in the lateral sides. The grooves 521 have a size in the transverse direction (Y) that permits extension of the first core parts 51p therein in the longitudinal direction (X).

The first core parts 51p and the second core part 52p define two of the effective magnetic flux regions 55 at contact areas between the first core parts 51p with the second core part 52p in the grooves 521. The first core parts 51p are movable relative to the second core part 52p in the longitudinal direction (X) from the tunable position to the assembled position.

Similar to the second embodiment, the bobbin unit 20a includes two main bodies 21, each of which is formed with the core-receiving compartment 22 along the longitudinal direction (X), and has the first and second winding portions. The main bodies 22 are connected to each other such that the first winding portions are disposed adjacent to each other and such that the second winding portions are disposed distal from each other. In addition, the transformer 200p includes two of the primary windings 30, each of which is wound around the first winding portion of a corresponding one of the main bodies 21, and two of the secondary windings 40, each of which is wound around the second winding portion of a corresponding one of the main bodies 21.

The first core parts 51p extend in the longitudinal direction (X) through the core-receiving compartments 22 in the main bodies 21, and are movable relative to the second core part 52p in the longitudinal direction (X) from the tunable position to the assembled position.

It should be noted herein that in the above mentioned embodiments, regardless of whether the transformer includes one primary winding and one secondary winding, or two primary windings and two secondary windings, with the structure of the core unit so designed such that the first core part is movable relative to the second core part, and with the bobbin unit specifically structured so as not to hinder movement of the first core part relative to the second core part, the size of the effective magnetic flux region defined between the first and second core parts can be varied to achieve a leakage inductance that complies with product requirements, at which time the first core part is disposed at the assembled position, and can be fixed in position with the use of an adhesive. Moreover, according to some embodiments of the present invention, the size of the effective primary magnetic flux area can be maintained while the size of the effective secondary magnetic flux area is adjusted, thereby ensuring stability at the primary winding side of the transformer.

While the present invention has been described in connection with what are considered the most practical and embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A transformer comprising:
a bobbin unit having a first winding portion and a second winding portion;
a primary winding wound around said first winding portion of said bobbin unit;
a secondary winding wound around said second winding portion of said bobbin unit, and coupled electromagnetically to said primary winding; and
a core unit mounted to said bobbin unit, and including a first core part, and a second core part that forms a magnetic circuit path with said first core part, said first core part being movable relative to said second core part from a tunable position to an assembled position for varying a size of an effective magnetic flux region defined between said first core part and said second core part.

2. The transformer as claimed in claim 1, wherein said effective magnetic flux region is an effective secondary magnetic flux area defined between said first core part and said second core part and proximate to said secondary winding, the size of said effective secondary magnetic flux area being varied while a size of an effective primary magnetic flux area defined between said first core part and said second core part and proximate to said primary winding is maintained.

3. The transformer as claimed in claim 2, wherein the size of said effective secondary magnetic flux area is different from the size of said effective primary magnetic flux area.

4. The transformer as claimed in claim 2, wherein said bobbin unit includes a main body that is formed with a core-receiving compartment along a longitudinal direction, and that has said first and second winding portions, said first core part extending through said core-receiving compartment, and being movable relative to said second core part in the longitudinal direction from the tunable position to the assembled position.

5. The transformer as claimed in claim 4, wherein said bobbin unit further includes an electrically conductive plate embedded in said main body, connected electrically to one of said primary and secondary windings, and adapted to define a capacitor with a metal part of a circuit board, to which the transformer is mounted.

6. The transformer as claimed in claim 2, wherein said first core part is an elongated core part that extends in a longitudinal direction, said second core part being an O-shaped core part that has opposite longitudinal sides, which extend in the longitudinal direction, and opposite lateral sides, which extend in a transverse direction perpendicular to the longitudinal direction, said second core part being formed with two grooves respectively in said lateral sides, each of said grooves extending in a vertical direction perpendicular to the longitudinal direction and the transverse direction, said first core part extending into said grooves, said primary and secondary effective magnetic flux areas being contact areas between said first and second core parts in said grooves respectively proximate to said primary and secondary windings.

7. The transformer as claimed in claim 2, wherein said bobbin unit includes two main bodies, each of which is formed with a core-receiving compartment along a longitudinal direction, and has said first and second winding portions, said main bodies being connected to each other such that said first winding portions are disposed adjacent to each other and such that said second winding portions are disposed distal from each other,
the transformer comprising two of said primary windings, each of which is wound around said first winding portion of a corresponding one of said main bodies, and two of said secondary windings, each of which is wound around said second winding portion of a corresponding one of said main bodies,
said first core part extending in the longitudinal direction through said core-receiving compartments in said main bodies, and being movable relative to said second core part in the longitudinal direction from the tunable position to the assembled position, said first core part including a central segment that corresponds to said primary windings and that has a first cross-,sectional area in a plane perpendicular to the longitudinal direction, and two end segments that are disposed at opposite ends of said central segment in the longitudinal direction, and that respectively correspond to said secondary windings, each of said end segments having a second cross-sectional area in a plane perpendicular to the longitudinal direction that is smaller than the first cross-sectional area.

8. The transformer as claimed in claim 2, wherein said second core part includes first and second sub-core parts, said first core part extending in a longitudinal direction, and being movable relative to said first and second sub-core parts in the longitudinal direction from the tunable position to the assembled position, each of said first and second sub-core parts being a C-shaped part that has opposite longitudinal sides extending in the longitudinal direction and a lateral side extending in a transverse direction perpendicular to the longitudinal direction, said first and second sub-core parts being disposed in contact with each other in the longitudinal direction such that said lateral sides of said first and second sub-core parts face each other, each of said first and second sub-core parts being formed with a groove in said lateral side thereof that extends in a vertical direction perpendicular to the longitudinal direction and the transverse direction, said first core part extending into said grooves in said first and second sub-core parts, said primary effective magnetic flux area being a contact area between said first core part and said first sub-core part in said groove in said first sub-core part and proximate to said primary winding, said secondary effective magnetic flux area being a contact area between said first core part and said second sub-core part in said groove in said second sub-core part and proximate to said secondary winding.

9. The transformer as claimed in claim 2, wherein said first core part is an elongated core part that extends in a longitudinal direction, said second core part being a C-shaped core part that has a longitudinal side, which extends in the longitudinal direction, and opposite vertical sides, each of which extends in a vertical direction perpendicular to the longitudinal direction and has an end surface in a plane perpendicular to the vertical direction, said end surfaces of said vertical sides being disposed in contact with said first core part, said primary and secondary effective magnetic flux areas respectively being areas of said end surfaces of said vertical sides of said second core part that are disposed in contact with said first core part and that are respectively disposed proximate to said primary and secondary windings, said first core part being movable relative to said second core part in the longitudinal direction from the tunable position to the assembled position.

10. The transformer as claimed in claim 2, wherein said first core part is an elongated core part that extends in a longitudinal direction,
said second core part being a U-shaped core part that has a longitudinal side, which extends in the longitudinal direction, and opposite transverse sides, each of which extends in a transverse direction perpendicular to the longitudinal direction and has a side surface in a plane of the longitudinal and transverse directions,
said side surfaces of said transverse sides being disposed in contact with said first core part, said primary and secondary effective magnetic flux areas respectively being areas of said side surfaces of said transverse sides of said second core part that are disposed in contact with said first core part and that are respectively disposed proximate to said primary and secondary windings, said first core part being movable relative to said second core part in the longitudinal direction from the tunable position to the assembled position.

11. The transformer as claimed in claim 2, wherein said core unit includes two of said first core parts, each of said first core parts being an elongated core part that extends in a longitudinal direction, said second core part being an 0-shaped core part that has opposite longitudinal sides, which extend in the longitudinal direction, and opposite lateral sides, which extend in a transverse direction perpendicular to the longitudinal direction, said first core parts being stacked in a vertical direction perpendicular to the longitudinal direction and the transverse direction,
said second core part being formed with a first groove in one of said lateral sides that is proximate to said primary winding, and a second groove in the other one of said lateral sides that is proximate to
said secondary winding, said first groove having a size in the vertical direction that permits extension of both of said stacked first core parts therein in the longitudinal direction, said second groove having a size in the vertical direction that permits extension of only a lower one of said stacked first core parts therein in the longitudinal direction,
said effective primary magnetic flux area being a contact area between an upper one of said stacked first core parts with said second core part in said first groove,
said effective secondary magnetic flux area being a contact area between the lower one of said stacked first core parts with said second core part in said second groove, the lower one of said first core parts being movable relative to said second core part in the longitudinal direction from the tunable position to the assembled position.

12. The transformer as claimed in claim 1, wherein said first core part is an elongated core part that extends in a longitudinal direction,
said second core part being an E-shaped core part, and including a connecting segment that extends in the longitudinal direction and three extension segments that extend from said connecting segment in a transverse direction perpendicular to the longitudinal direction and that are spaced apart from each other,
said first core part being disposed in a vertical direction perpendicular to the longitudinal direction and the transverse direction relative to said second core part, said effective magnetic flux region being an area of contact between said first core part and a central one of said extension segments of said second core part that is interposed between the other two of said extension segments, said first core part being movable in the transverse direction relative to said second core part from the tunable position to the assembled position.

13. The transformer as claimed in claim 12, wherein the central one of said extension segments extends into said bobbin unit such that said primary and secondary windings are respectively distal from and proximate to said first core part.

14. The transformer as claimed in claim 1, wherein said first core part is an elongated core part that extends in a longitudinal direction,
said second core part being an E--shaped core part, and including a connecting segment that extends in the longitudinal direction and three extension segments that extend from said connecting segment in a transverse direction perpendicular to the longitudinal direction and that are spaced apart from each other,
said first core part being disposed in the transverse direction relative to said second core part, said effective magnetic flux region being areas of contact between said first core part and two outer ones of said extension segments of said second core part that have a central one of said extension segments interposed there between, said first core part being movable in the longitudinal direction relative to said second core part from the tunable position to the assembled position.

15. The transformer as claimed in claim 14, wherein said first core part has a length in the longitudinal direction that is not smaller than that of said connecting segment of said second core part.

16. The transformer as claimed in claim 14, wherein the central one of said extension segments extends into said bobbin unit such that said primary and secondary windings are respectively distal from and proximate to said first core part.

17. The transformer as claimed in claim 1, wherein said second core part is an E-shaped core part, and includes a connecting segment that extends in a longitudinal direction, and three extension segments that extend from said connecting segment in a transverse direction perpendicular to the longitudinal direction and that are spaced apart from each other,
said first core part being an elongated core part that extends in the longitudinal direction, and being formed with a groove that extends in the transverse direction, and that has a size in the longitudinal direction greater than that of a central one of said extension segments of said second core part that is interposed between the other two of said extension segments,
said first core part being disposed in the transverse direction relative to said second core part such that said groove is registered with said central one of said extension segments, and such that there is an air gap between said first core part and said central one of said extension segments,
said first core part being movable in the longitudinal direction relative to said second core part from the tunable position to the assembled position for varying configuration of said air gap so as to vary the size of said effective magnetic flux region.

18. The transformer as claimed in claim 17, wherein said bobbin unit is formed with an extension groove disposed between said primary and secondary windings, and said first core part extends into said bobbin unit.

19. The transformer as claimed in claim 17, wherein said first core part has a length in the longitudinal direction that is not smaller than that of said connecting segment of said second core part.

20. The transformer as claimed in claim 1, wherein said second core part is an E-shaped core part, and includes a connecting segment that extends in a longitudinal direction, and three extension segments that extend from said connecting segment in a transverse direction perpendicular to the longitudinal direction and that are spaced apart from each other,
said first core part being an elongated core part that extends in the longitudinal direction, and that has a thick segment and a thin segment, said thin segment being thinner in the transverse direction than said thick segment such that said thick and thin segments cooperate to form a junction there between, a central one of said extension segments of said second core part being registered with said thin segment such that said central one of said extension segments of said second core part forms an air gap with said junction,
said first core part being movable in the longitudinal direction relative to said second core part from the tunable position to the assembled position for varying configuration of said air gap so as to vary the size of said effective magnetic flux region.

21. The transformer as claimed in claim 20, wherein said first core part extends into said bobbin unit with said junction disposed between said primary and secondary windings.

22. The transformer as claimed in claim 20, wherein said first core part has a length in the longitudinal direction that is not smaller than that of said connecting segment of said second core part.

23. The transformer as claimed in claim 1, wherein said second core part is an E-shaped core part, and includes a connecting segment that extends in a longitudinal direction, and three extension segments that extend from said connecting segment in a transverse direction perpendicular to the longitudinal direction and that are spaced apart from each other,
said first core part being an elongated core part that extends in the longitudinal direction, and that has a first segment and a second segment disposed adjacent to each other, said second segment having a size in the transverse direction that gradually decreases along the longitudinal direction away from said first segment,
a central one of said extension segments of said second core part being disposed in contact with said second segment,
said first core part being movable in the longitudinal direction relative to said second core part from the tunable position to the assembled position for adjusting relative position of said second segment of said first core part with said central one of said extension segments of said second core part so as to vary the size of said effective magnetic flux region.

24. The transformer as claimed in claim 23, wherein said first core part extends into said bobbin unit, said primary winding being wound around said first segment, said secondary winding being wound around said second segment.

25. The transformer as claimed in claim 1, wherein each of said first and second core parts is an E-shaped core part, and includes a connecting segment that extends in a transverse direction, and three extension segments that extend from said connecting segment in a longitudinal direction perpendicular to the transverse direction and that are spaced apart from each other, said first and second core parts being disposed such that each of said extension segments of said first core part is disposed in contact with a corresponding one of said extension segments of said second core part along the longitudinal direction, and such that said effective magnetic flux region is defined by a central one of said extension segments of said first core part and the corresponding one of said extension segments of said second core part, said first core part being movable relative to said second core part in the longitudinal direction from the tunable position to the assembled position for varying the size of said effective magnetic flux region.

26. The transformer as claimed in claim 25, comprising two of said primary windings disposed adjacent to each other, and two of said secondary windings disposed distal from each other, the central one of said extension segments of said first core part and the corresponding one of said extension segments of said second core part extending into said bobbin unit.

27. The transformer as claimed in claim 1, wherein each of said first and second core parts is an E-shaped core part, and includes a connecting segment that extends in a transverse direction, and three extension segments that extend from said connecting segment in a longitudinal direction perpendicular to the transverse direction and that are spaced apart from each other, each of said extension segments having an end remote from said connecting segment that is provided with a protrusion in the longitudinal direction,
said first and second core parts being disposed such that each of said extension segments of said first core part is registered with a corresponding one of said extension segments of said second core part in the longitudinal direction, and such that said protrusion of each of said extension segments of said first core part is disposed in contact with said protrusion of the corresponding one of said extension segments of said second core part in the transverse direction,
said effective magnetic flux region being defined between said protrusion of a central one of said extension segments of said first core part and said protrusion of the corresponding one of said extension segments of said second care part,
said first core part being movable relative to said second core part in the longitudinal direction from the tunable position to the assembled position for varying the size of said effective magnetic flux region.

28. The transformer as claimed in claim 27, comprising two of said primary windings disposed adjacent to each other, and two of said secondary windings disposed distal from each other, the central one of said extension segments of said first core part and the corresponding one of said extension segments of said second core part extending into said bobbin unit.

29. The transformer as claimed in claim 1, wherein said core unit includes two of said first core parts, each of said first core parts being an elongated core part that extends in a longitudinal direction, said second core part being an 0-shaped core part that has opposite longitudinal sides, which extend in the longitudinal direction, and opposite lateral sides, which extend in a transverse direction perpendicular to the longitudinal direction, said first core parts being juxtaposed in the transverse direction,
said second core part being formed with two grooves respectively in said lateral sides, said grooves having a size in the transverse direction that permits extension of said first core parts therein in the longitudinal direction,
said first core parts and said second core part defining two of said effective magnetic flux regions at contact areas between said first core parts with said second core part in said grooves, said first core parts being movable relative to said second core part in the longitudinal direction from the tunable position to the assembled position.

30. The transformer as claimed in claim 29, wherein said bobbin unit includes two main bodies, each of which is formed with a core-receiving compartment along the longitudinal direction, and has said first and second winding portions, said main bodies being connected to each other such that said first winding portions are disposed adjacent to each other and such that said second winding portions are disposed distal from each other,
the transformer comprising two of said primary windings, each of which is wound around said first winding portion of a corresponding one of said main bodies, and two of said secondary windings, each of which is wound around said second winding portion of a corresponding one of said main bodies,
said first core parts extending in the longitudinal direction through said core-receiving compartments in said main bodies, and being movable relative to said second core part in the longitudinal direction from the tunable position to the assembled position.
